(19) United States
(12) Patent Application Publication
(10) Pub. No.: US 2004/0215524 A1
(43) Pub. Date: Oct. 28, 2004

(54) Automated iterative offering method for communications networks

(76) Inventor: Nicholas David Parkyn, Oakville (CA)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/421,289

(22) Filed: Apr. 23, 2003

(51) Int. Cl. G06F 17/60

(52) U.S. Cl. 705/26

(57) ABSTRACT

A vendor system, accessible via a cellular phone network, WiFi or wired network responds to purchase inquiries with iterative pricing. If an initial offer is declined, the vendor system can initiate a series of interactions with a customer to help determine a follow-up price for the same or a related product (or product bundle). The customer interface is provided by a self-service front end, while price determinations are made by a virtual customer service representative using a rule-based expert system. Once an offer is accepted, an order is placed.

### BACKGROUND OF THE INVENTION

The present invention relates to computer-based business methods and, more particularly, to commercial network systems that take customers from product selection to offer to order. A major objective of the invention is to provide for enhanced profits for data service providers.

The increasing penetration into the marketplace of computer networks in general and the Internet in particular has revolutionized commerce. Internet sales now account for a substantial percentage of retail sales. Commercial web sites provide product and service catalogs and order placement. Some commercial sites use sophisticated artificial intelligence systems to guide product selection and to make well-targeted offers for sale.

Further developments in networking promise to greatly expand the importance of online commerce. Wireless networking, e.g., WiFi (“wireless fidelity”), is making it possible for portable network and Internet access. It is contemplated that various physical commercial sites, e.g., coffee shops and airports, will offer “hotspots” where patrons can go to obtain software applications and network (including Internet) access using their wireless-enabled laptop computers, tablet computers, and personal-digital assistants (PDAs).

Developments in mobile telephony are also expected to expand commerce through wider access to the Internet and to other computer and communications networks. First generation analog cell phones provided voice communications. Second generation digital cell phones provided higher quality voice and limited data communications. Third generation cell phones are to provide data communications as speeds suitable for streaming video, for example. Thus, the general populace can have Internet and network access with them everywhere and all the time.

The increasing ubiquity of data communications makes possible a large market for on-demand data services. In one commerce model, data communication service companies offer pay-as-you-go communications services—such as the ability to follow a sporting event. A Wi-Fi patron or a cell-phone customer can call a service provider, which provides an option of text-only, highlights, or full video of a sporting event. Pricing can be provided before or after the customer makes a selection. Then the customer chooses to order the desired level of service.

The large potential customer base for short-term pay-for-perceived-value data services makes this market attractive to potential providers. On the other hand, the very size of the market can make it very competitive. This will be the case especially where the same service (e.g., sporting event) is provided by competing services. What is needed is a marketing scheme that can provide for profit maximization in this potentially very competitive marketplace.

### SUMMARY OF THE INVENTION

The present invention provides for computer-driven vendor system that presents iterative offerings to customers. When a customer selects a product but declines to order at the offered price, the vendor system presents a revised offer (for the same or related product) or invites a counter offer. The revised offer can occur directly or after some computer-directed interaction with the customer. For example, the revised offer can be based on a price solicited from customer.

While the second offer can be predetermined, the invention contemplates a second offer being generated according to a function that is evaluated during the session between vendor and customer. On-line factors that can affect the second offer include data regarding the particular customer, the timeliness of the inquiry, current sales data, and competitor data. More generally, the vendor computer system can use the forms of expertise available to human customer service and sales individuals to negotiate a favorable price. Moreover, the vendor computer system can, in many cases, use information in a more up-to-date fashion

The invention provides for flexible pricing to generate profits in a highly competitive market such as that for data services. Where the customer is not price sensitive or where the customer's demand is high, an order can be taken at the initially high price. If the offer is not accepted, revenue still can be secured through the iterative offerings. The tactics have parallels with those used by human customer service representatives, but the advantages can be achieved at higher speeds, at lower cost, and with better information. These and other features and advantages of the invention are apparent from the description below with reference to the followings drawings.

### BRIEF DESCRIPTION OF THE DRAWINGS

FIG. 1 is a schematic diagram of a vendor system implementing the present invention and connected to customer devices connected over the Internet.

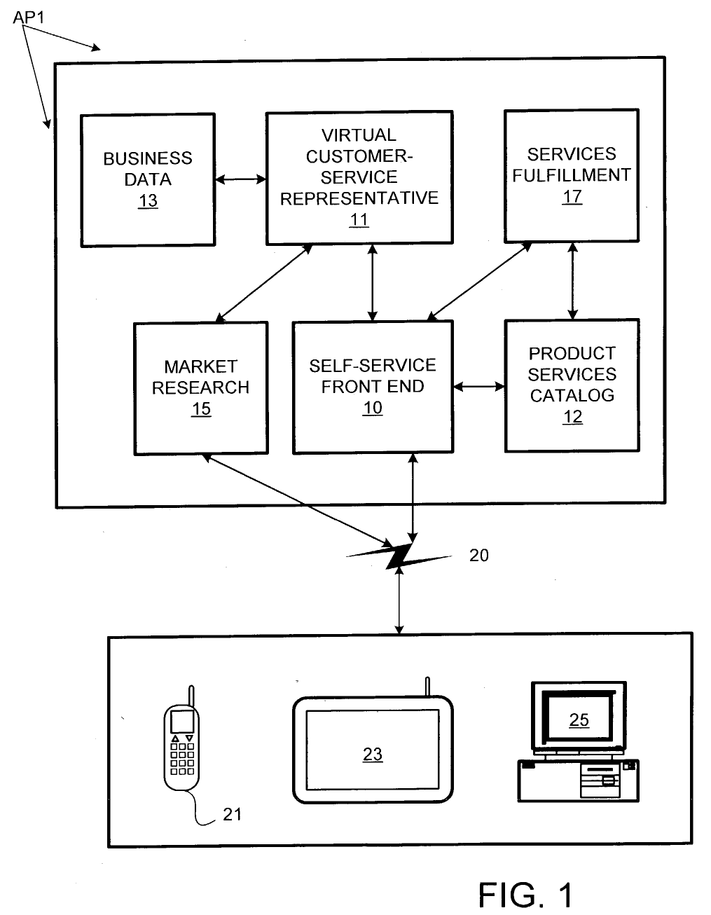

FIG. 2 is a flow chart of a method in accordance with the present invention.

### DETAILED DESCRIPTION

In accordance with the present invention, a vendor computer system AP1 comprises a self-service front-end module 10, a virtual customer-service representative (VCSR) module 11, a product service catalog 12, a business data module 13, a market research module 15, and a services fulfillment module 17. Self-service module 10 and market research module 15 are “front-end” modules in that they interface directly with the Internet 20. VCSR module 11, catalog 12, business data module 13, and services fulfillment module are not directly coupled to the Internet 20. Customer access to vendor system AP1 can be had through various devices including a third-generation cellular phone 21, a WiFi-enabled tablet computer 23, or a “wired” desktop computer 25.

Self-service front-end module 10 can provide an animated on-screen character that steps a customer through the self-service steps while actively marketing the product service. Based on customer interaction and feedback, this animated customer-service representative can be more or less active. VCSR module 11 implements an artificial intelligence system using a rule-based expert system. To this end, VCSR module 11 is populated with marketing rules related to pricing, including up selling, cross-selling, special offers and incentives.

VCSR module 11 is connected to catalog 12 for accessing product descriptions and pricing information. VCSR module 11 is also connected to business data module 13 for accessing business policy, customer data. Business data module 13 includes both business intelligence and billing information.

Market research module 15 contains information about competitor offerings. The competitor information is updated by using Internet “spiders”, “bots” and “agents”. These can, for example, act as virtual customers to gather competitor prices. This module can contact a competitor while a customer is connected for price-matching purposes.

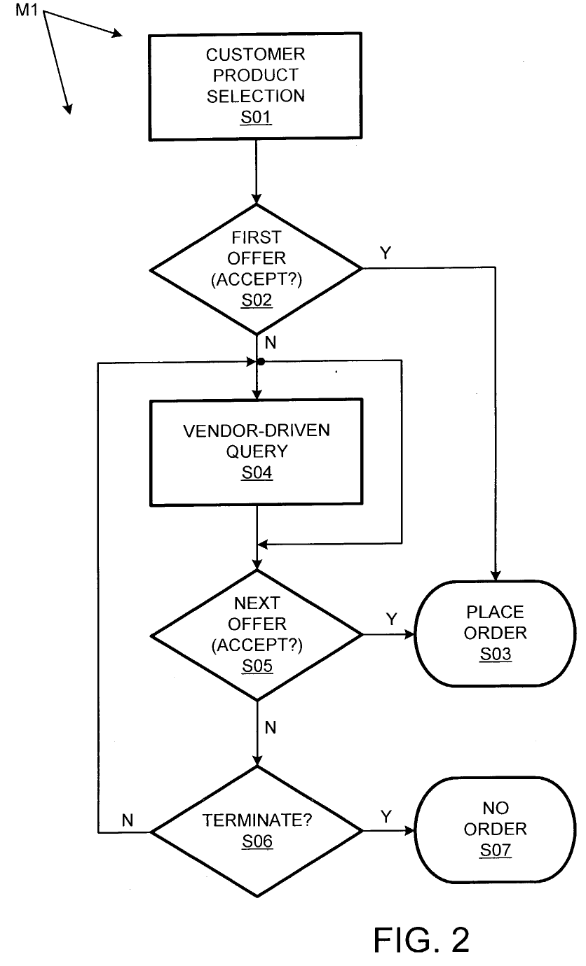

A method M1 practiced using the vendor system AP1 is flow charted in FIG. 2. After connecting to vendor system AP1, the customer selects a product of interest for possible purchase at step S01. The selection may involve browsing through product pages or answering vendor-presented queries or any number of other selection approaches. Once the customer makes a selection, the vendor system offers the product at a first price at step S02. If the customer accepts the offer, vendor system AP1 places an order at step S03.

The customer has the option of declining the first offer. This decision to decline the offer can be determined either by an explicit action (such as pushing a “decline” button) or by lapse of time without acceptance.

In the event the customer declines the first offer, method M1 provides two alternatives. The vendor system AP1 can then initiate a routine aimed at determined an alternative offer for the customer at step S04. This can involve asking what price the customer would be willing to pay or if the customer is aware of a better offer by a competing vendor or asking if the customer is interested in some bundling of the product with other products in exchange for a better overall rate. Once this interaction is completed, vendor system AP1 formulates and presents a second offer at step S05. Alternatively, method M1 can proceed from the rejection of the first offer directly to the presentation of the second offer.

The second offer can be a different price for the same product. Alternatively, the second offer can involve a price with an alternative product offering. Either additional products can be added or some “features” removed. Preferably, an artificial intelligence model of a customer service representative or a sales representative is used in formulating the second offer.

If the customer accepts the second offer, an order is placed at step S03. Otherwise, a determination is made at step S06 whether to present a subsequent offer. This determination can be made based on the a number of factors including the number of offers already made, the customer's indicated interest in a further offer, and the availability of previously unpresented bundling alternatives. If a further offer is indicated, method M1 returns to step S04, if that option is implemented, or to step S05. If no further offer is indicated, then method M1 terminates at step S07 without placing an order.

The invention provides for a variety of customers and vendors. For example, the customer may be a human accessing a primary service provider (mobile telephone carrier, WiFi operator, Internet Service Provider) or a vendor providing services to or through a primary service provider. The customer may also be a company (e.g., a WiFi operator ordering services). The vendor can be a primary service provider, company with a website accessed through the primary service provider, or a service wholesaler (selling services as an affiliate with the primary service provider).

In one scenario, a patron of a coffee shop with a tablet PC accesses the shop's WiFi network. Some basic services are free, but sporting events are an “extra cost option”. The first offer for a video presentation of a sporting event is a fixed price. However, if that is declined, a number of factors go into determining the second offer: how often does the customer frequent the shop and how much does the customer typically spend, does the customer have time to shop for a better price, how many other customers have ordered the sporting event, what are competitors charging for the sporting event, etc.

The invention contemplates price matching. In this case, the vendor system can query the customer for a price match. The customer can give a price and identify a competitor (e.g., from a checklist). The vendor system can then contact the competitor system using its market research module 17 to verify the price match. To save time, market research module 17 can act as a virtual customer to customers to gather competitor pricing information.

For an example of price differentiation for a single sporting event, there could be options for: 1) full video with customer-controlled instant reply; 2) full video without replay; 3) highlights only; 4) text only reporting of scores, etc. A vendor can use some alternatives in the first offer, while reserving some for the second. Also, a second offer could bundle in a second sporting event for a marginal additional cost.

Interactive games and game shows are another market for iterative pricing. Customers might wish to access an interactive game show for only as long as they can participate without losing the right to further participation. Again, iterative pricing can provide a simple profitable first alternative, with more complex or less profitable alternatives being presented if the first offer is declined. These and other modifications to and variations upon the detailed embodiments are provided for by the present invention, the scope of which is determined by the following claims.

What is claimed is:

1. A computer-based automated business method comprising:
a) responding to a data service request by a customer over a network by making an initial offer over said network to said customer, said initial offer specifying a first set of products and price;
b) if the offer set forth in a) is accepted, effecting an order for said first set of products; and
c) if the offer set forth in a) is declined, making a second offer over said network to said customer for a second set of products.

2. A computer-based automated business method as recited in claim 1 wherein step c further involves, after said offer is declined and before making said second offer, querying said customer for information to be used in determining said second offer.

3. A computer-based automated business method as recited in claim 2 wherein step c further involves requesting a price to match from said customer.

4. A computer-based automated business method as recited in claim 3 wherein step c further involves, after receiving said price to match, contacting a competitor for confirmation of said price to match.

5. A computer-based automated business method as recited in claim 1 wherein step c further involves determining said second offer from information obtained about said customer prior to said request.

6. A computer-based automated business method as recited in claim 1 wherein step c further involves determining said second offer based in part on an interval between a time said request is made and a time a service associated with said second set of products is to begin.

7. A computer-readable medium including a computer program for implementing a computer-based method comprising:
a) responding to a data service request by a customer over a network by making an initial offer over said network to said customer, said initial offer specifying a first set of products and price;
b) if the offer set forth in a) is accepted, effecting an order for said first set of products;
c) if the offer set forth in a) is declined, making a second offer over said network to said customer for a second set of products.

8. A computer-readable medium as recited in claim 7 wherein step c further involves, after said offer is declined and before making said second offer, querying said customer for information to be used in determining said second offer.

9. A computer-readable medium as recited in claim 8 wherein step c further involves requesting a price to match from said customer.

10. A computer-readable medium as recited in claim 9 wherein step c further involves, after receiving said price to match, contacting a competitor for confirmation of said price to match.

11. A computer-readable medium as recited in claim 7 wherein step c further involves determining said second offer from information obtained about said customer prior to said request.

12. A computer-readable medium as recited in claim 7 wherein step c further involves determining said second offer based in part on an interval between a time said request is made and a time a service associated with said second set of products is to begin.
